(19) United States
(12) Patent Application Publication
(10) Pub. No.: US 2022/0358472 A1
(43) Pub. Date: Nov. 10, 2022

(54) ARCHITECTURE FOR CREATING AN ELECTRONIC CURRENCY INTEROPERABLE BETWEEN A PLURALITY OF MONETARY INSTITUTIONS

(71) Applicant: BPCE, Paris (FR)

(72) Inventors: José Luu, Igny (FR); Cyril Vignet, Paris (FR)

(21) Appl. No.: 17/765,400

(22) PCT Filed: Sep. 29, 2020
(86) PCT No.: PCT/EP2020/077263

§ 371 Date: Mar. 30, 2022

(30) Foreign Application Priority Data
Sep. 30, 2019 (FR) FR1910817

(51) Int. Cl. G06Q 20/06; G06Q 20/38; G06Q 20/14

(52) U.S. Cl. CPC G06Q 20/065; G06Q 20/389; G06Q 20/14; G06Q 20/381; G06Q 20/4037

(57) ABSTRACT

The invention concerns an architecture comprising: at least one platform of an electronic money institution. The EMI platform being associated with at least one platform of a scriptural money holding establishment. A blockchain to which the EMI platform is connected, the blockchain allowing the EMI platform to create universal electronic money tokens as a function of the amount of scriptural money held by the EMI platform. The invention also allows a user of an EMI to request universal tokens from the EMI platform. The invention also allows the EMI platform to supply a user with universal tokens in response to such a request and allows a user to directly exchange universal tokens with users of the EMI.

### CROSS-REFERENCE TO RELATED APPLICATIONS

This application claims the benefit of International application number PCT/EP2020/077263, filed Sep. 29, 2020 and French patent application number 1910817, filed on Sep. 30, 2019, the entire contents of which are incorporated herein by reference.

### TECHNICAL FIELD

The invention relates to an architecture for creating by means of a blockchain an electronic currency interoperable between a plurality of monetary institutions.

### BACKGROUND

Blockchains are technologies that enable their users to store and transmit data in a secure manner and without any central control body, thanks to a distributed database whose information sent by the users and internal links are verified and grouped at regular time intervals in blocks, thereby forming a chain (see in particular the article “Blockchain” on the site of the collaborative encyclopaedia Wikipedia® and the article of the online newspaper “Le Journal du Net” available at the address https://www.journaldunet.com/economie/finance/1195520-blockchain-avril-2019/).

This fast-growing technology is used in particular to enable the users to carry out transactions, validated by a consensus mechanism between nodes in the chain (called “miners”), and finds application more particularly in the creation and management of virtual currencies, or crypto-currencies, such as for example Bitcoin®, Ether®, Monero® or Peercoin® (or PPcoin®).

In Europe, the EMD2 directive of September 16^{th}, enables qualified institutions, called electronic money institutions (EMI), to represent scriptural currency, in particular the euro, in various electronic currency formats, and thus to perform fund handling operations more easily, in particular account management, counting, transfers or sequestrations, provided that a sufficiently large sum in scriptural currency is billetted in a suitable institution.

This directive has allowed for the emergence of many electronic currencies, based on the same type of centralised architecture based on a central server which manages the user accounts and implements the different services for a given monetary institution.

However, the current solutions are not fully satisfactory, in that each EMI institution creates its own electronic currency completely independently of the other EMI institutions, said electronic currency not being directly exchangeable between two different EMI institutions.

Thus, in order to be able to use different electronic currencies and benefit from the different services offered thereby, a user must create an account in each EMI institution producing said electronic currencies, and perform the fund transfers themselves via their scriptural currency bank, which turns out to be relatively complex and tedious in practice.

Therefore, individual users do not fully profit of the advantages offered by electronic currency, and its use is more limited to particular technical and/or commercial niches.

### SUMMARY OF THE INVENTION

The invention aims to improve the prior art by providing in particular an architecture to enable the creation of a networked electronic currency that is interoperable between a plurality of electronic money institutions (EMI), in order to enable users to be able to easily benefit from the advantages offered by the electronic currency.

To this end, the invention provides an architecture for creating an electronic currency interoperable between a plurality of monetary institutions, said architecture comprising:
at least one electronic money institution (EMI) platform, said EMI platform being associated to at least one platform of a scriptural currency billetting institution;
a blockchain to which the EMI platform is connected, said blockchain comprising:
means for allowing the EMI platform to create electronic currency universal tokens according to the amount of scriptural currency billetted by said EMI platform;
means for allowing a user of the EMI institution to request universal tokens from the EMI platform;
means for allowing the EMI platform to supply a user with universal tokens in response to such a request;
means for allowing a user to directly exchange universal tokens with users of the EMI institution.

### BRIEF DESCRIPTION OF THE DRAWING

Other particularities and advantages of the invention will appear in the following description, made with reference to the appended FIGURE,

FIG. 1 representing an architecture according to an embodiment of the invention.

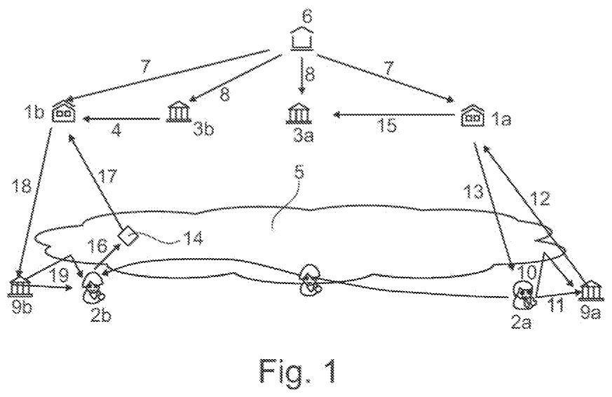

### DETAILED DESCRIPTION

Referring to this FIGURE, an architecture for creating an electronic currency interoperable between a plurality of monetary institutions is described hereinbelow.

The architecture comprises at least one electronic money institution (EMI) platform 1a, 1b, said platform comprising means for creating and supplying electronic currency tokens to the users 2a, 2b of the EMI institution.

In the represented embodiment, the architecture comprises at least two platforms 1a, 1b of electronic money institutions (EMI) as described before.

In order to comply with the different directives regulating EMI institutions, in particular the European directive EMD2, each EMI institution must be associated with a scriptural currency institution, in which an amount of scriptural currency corresponding to the amount of electronic currency that the EMI institution wishes to issue must be billetted by said EMI institution to guarantee the validity of the electronic currency issued by said EMI institution.

For this purpose, as represented in the FIGURE, each EMI platform 1a, 1b is associated to at least one platform 3a, 3b of such a scriptural currency billetting institution, each scriptural currency platform 3a, 3b comprising means for sending to the EMI platform 1a, 1b to which it is associated a notification 4 comprising information on the total amount of scriptural currency billetted for said EMI platform in said scriptural currency institution.

The architecture further comprises a blockchain 5 to which the EMI platform(s) 1a, 1b is (are) connected, said blockchain comprising means for allowing said EMI platform(s) to create electronic currency universal tokens according to the amount of scriptural currency billetted by said EMI platform(s).

In the FIGURE, each EMI platform 1a, 1b is connected to the blockchain 5, which comprises means to allow the EMI platforms 1a, 1b to cooperate in order to create electronic currency universal tokens according to the amount of scriptural currency billetted in their respective scriptural currency institution.

Thus, thanks to a cooperation of the different EMI institutions within a same blockchain 5, an electronic currency that can be used by each of said institutions is created, which allows users 2a, 2b of all types, in particular individuals, to be able to easily benefit from the advantages offered by electronic currency.

In particular, a user 2a, 2b could use these universal tokens to directly perform transactions with other users 2a, 2b of different EMI institutions connected to the blockchain 5, and that being so without having to create accounts in each of said EMI institutions, or to change electronic currency for each of the other users 2a, 2b with whom he wishes to perform transactions.

The architecture further comprises a platform 6 of a central bank which comprises means for regulating the creation of universal tokens by the EMI platforms 2a, 2b according to the amount of scriptural currency billetted by each of said EMI platforms.

For this purpose, the central platform 6 comprises means for sending notifications 7, 8 respectively to each EMI platform 1a, 1b and to the billetting platform 3a, 3b associated thereto, in order to be able to verify the correlation between the amount of universal tokens issued by said EMI platform and the amount of scriptural currency recorded by said billetting platform.

In particular, the central platform 6 could interact with the EMI 1a, 1b and billetting 3a, 3b platforms through the blockchain 5, which enables an administrator of said central platform to know in real-time the total amount of electronic currency tokens circulating within the architecture.

To enable the users 2a, 2b of the different EMI institutions to easily acquire electronic currency tokens, the blockchain 5 comprises means to allow:
on the one hand, a user 2a of a given EMI institution to request universal tokens from the corresponding EMI platform 1a; and
on the other hand, an EMI platform 1a to supply a user 2a with universal tokens in response to such a request.

For this purpose, as represented in the FIGURE, each EMI platform 1a, 1b is associated to at least one scriptural currency local platform 9a, 9b, for example a bank, said local platform comprising means for interacting with said EMI platform to supply a user 2a, 2b with universal tokens.

In particular, the blockchain 5 comprises means for allowing a user 2a to send a query 10 to the local platform 9a related to his EMI institution to request universal tokens from the corresponding EMI platform 1a, said query specifying in particular the amount of universal tokens that said user wishes to acquire.

Afterwards, to complete this request, the user 2a sends to the local platform 9a a notification 11 to provide an amount of scriptural currency corresponding to the amount of universal tokens that he wishes to acquire.

For example, the notification 11 may be a message to authorise the transfer of the requested amount of scriptural currency, in particular from an account held by the user 2a in the institution related to the local platform 9a. The notification 11 could also be a bank transfer to provide the requested amount to the local platform 9a, in particular to supply the account of the user 2a for the transfer of said amount.

Afterwards, the local platform 9a interacts with the EMI platform 1a to supply the user 2a with the amount of universal tokens that he has requested. For this purpose, the local platform 9a comprises means for transmitting to the EMI platform 1a, in particular by sending an appropriate notification 12, the amount of scriptural currency provided by the user 2a.

Finally, after reception of the notification 12, the EMI platform 1a supplies the user 2a with an amount of universal tokens corresponding to the amount of scriptural currency provided by said user. For this purpose, the EMI platform 1a sends to the user 2a a notification 13 to supply him with the universal tokens, in particular to credit with said universal tokens an electronic currency account on the name of said user in the corresponding EMI institution.

In parallel with sending of the notification 13, the EMI platform 1a sends to the platform 3a of its billetting institution a notification 15 to add the amount of scriptural currency provided by the user 2a to his total amount of scriptural currency billetted in said institution.

The blockchain 5 further comprises means for allowing a user 2a to directly exchange universal tokens with users 2b of all the EMI institutions connected to said blockchain.

For this purpose, the blockchain 5 may comprise means for implementing smart contract type computer programs suited for transactions between the users 2a, 2b, or means for implementing a distributed ledger device.

The blockchain 5 also comprises an application 14 which comprises means for enabling a user 2a, 2b to a request a reimbursement in scriptural currency of an amount of universal tokens.

In particular, each local platform 9a, 9b comprises means for interacting with the EMI platform 1a, 1b with which it is associated to supply scriptural currency to a user 2a, 2b having a requested a reimbursement.

The application 14 also comprises an algorithm arranged, when a user 2b requests such a reimbursement, so as to:
assess a relevance criterion for each EMI platform 1a, 1b connected to the blockchain 5;
select, according to said criterion, the most relevant EMI platform 1b for performing said reimbursement.

In particular, the application 14 may be arranged so as to implement this algorithm by means of a smart contract, which allows improving the reliability and the rapidity of said implementation.

The use of such an algorithm proves to be particularly advantageous for EMI institutions, in that some directives, in particular the EMD2 directive, require a reimbursement of the users 2a, 2b without delay, excluding technical delays for fund transfers, and with proven invoicing, i.e. without fees for said users. In particular, such an algorithm allows avoiding the use of compensation operations to rebalance the accounts of the EMI institutions.

Nonetheless, the application 14 could also be arranged so as to allow a user 2a, 2b to request a reimbursement before the EMI platform 1a, 1b of his EMI institution if he so wishes, provided that said EMI institution has a sufficient amount of scriptural currency in its associated billetting institution.

Advantageously, the application 14 may comprise means for offering to a user 2a, 2b requesting a reimbursement to choose between several options for obtaining said reimbursement, in particular between a direct reimbursement by his EMI institution or an indirect reimbursement by an EMI institution automatically selected by the algorithm.

The relevance criterion of an EMI platform 1a, 1b may comprise information on the total amount of scriptural currency held by the associated billetting institution and/or information on the country in which the EMI institution related to said EMI platform is established.

In particular, the algorithm may be arranged so as to select the EMI platform 1a, 1b whose total amount of billetted scriptural currency is the greatest for performing the reimbursement of the user 2b, in order to guarantee to said user a rapid reimbursement with the aforementioned advantages.

Advantageously, the algorithm may also be arranged so as to select as a priority the EMI platforms 1a, 1b whose associated EMI institutions are located in the same country as the user 2a, 2b requesting the reimbursement, which also allows facilitating the implementation of said reimbursement.

Referring to the FIGURE, when a user 2b wishes to obtain a reimbursement in scriptural currency, in particular after a transaction in universal tokens with another user 2a, he sends a query 16 to the application 14 to request such a reimbursement.

Afterwards, the application 14 selects the EMI platform 1b having to perform the reimbursement according to the choice of the user 2b, and sends to said EMI platform a notification 17 to carry out said reimbursement.

If the selected EMI platform 1b is that one of the EMI institution of the user 2b, the notification 17 may comprise, for example, an authorisation to debit the electronic currency account held by said user in said institution.

Similarly, if the selected EMI platform 1b is that one of an EMI institution other than that of the user 2b, the notification 17 may comprise information on the EMI institution of said user and/or the EMI platform associated to said institution, in order to allow the selected EMI platform 1b to interact with the adequate EMI platform to obtain a transfer in universal tokens provided by said user.

After having received the requested amount of universal tokens, the selected EMI platform 1b sends to the local platform 9b associated thereto a notification 18 to carry out the reimbursement in scriptural currency, said notification comprising for example a transfer of the requested amount of scriptural currency.

Finally, to complete the reimbursement, the local platform 9b sends a notification 19 to the user 2b, said notification comprising for example:
if the user 2b holds an account in the scriptural currency institution related to said local platform: information relating to the credit of said account with the amount of scriptural currency;
if the user 2b does not hold an account in said institution: a confirmation of a transfer of said amount to the account he holds in another institution.

Advantageously, the blockchain 5 comprises means for memorising a link between an electronic currency account held by a user and the transfers in electronic and/or scriptural currency performed to debit and/or credit said account. Thus, good traceability of currency flows is guaranteed, which makes it easier to secure them, in particular by means of procedures as provided for by the anti-money laundering and counter-terrorism financing protocols (AML/CFT).

What is claimed is:

1. An architecture for creating an electronic currency interoperable between a plurality of monetary institutions, the architecture comprising:
an electronic money institution platform being associated to a scriptural currency billing platform of a scriptural currency billetting institution;
a blockchain to which the electronic money institution platform is connected, the blockchain configured to allow:
the electronic money institution platform to create electronic currency universal tokens according to the amount of scriptural currency billetted by the electronic money institution platform;
a first user of the electronic money institution to request universal tokens from the electronic money institution platform;
the electronic money institution platform to supply the user with universal tokens in response to the request; and
the first user to directly exchange universal tokens with other users of the electronic money institution.

2. The architecture according to claim 1, comprising two electronic money institution platforms of a first electronic money institutions a and a second electronic money institution each of the electronic money institution platforms being associated to the scriptural currency billing platform and each of the two electronic money institution platforms being connected to the blockchain, the blockchain configure to allow:
the electronic money institution platforms to cooperate in order to create electronic currency universal tokens according to the amount of scriptural currency billetted by each of the electronic money institution platforms;
the first user of the first electronic money institution to request universal tokens from the second electronic money institution platform;
the first user to directly exchange universal tokens with a second users a second electronic money institution connected to the blockchain.

3. The architecture according to claim 1, comprising a central bank platform of a central bank for regulating the creation of universal tokens by the electronic money institution platform according to the amount of scriptural currency billetted by the electronic money institution platform.

4. The architecture according to claim 1, wherein the EMI platform is associated to a scriptural currency local platform, the local platform configured to interact with the electronic money institution platform to supply a first user with universal tokens or with scriptural currency.

5. The architecture according to claim 4, wherein the blockchain is configured to allow a first user to send a query to the scriptural currency local platform, in order to request universal tokens from the electronic money institution platform.

6. The architecture according to claim 4, wherein the local platform is configured for transmitting to the electronic money institution platform an amount of scriptural currency provided by the first user, the electronic money institution platform supplying the first user with an amount of universal tokens corresponding to the amount of scriptural currency.

7. The architecture according to claim 4, wherein the blockchain comprises an application configured:
to allow the first user to request a reimbursement in scriptural currency of an amount of universal tokens;
and includes an algorithm arranged, when first user requests the reimbursement, to:
assess a relevance criterion for a plurality of electronic money institution platforms; and
select, according to the relevance criterion, the most relevant electronic money institution platform of the plurality of electronic money institution platforms to perform the reimbursement.

8. The architecture according to claim 7, wherein the relevance criterion of the electronic money institution platform comprises information on the total amount of scriptural currency billetted by the electronic money institution platform or information on the country in which the electronic money institution related to electronic money institution platform is established.

9. The architecture according to claim 8, wherein the algorithm is configured to select the electronic money institution platform whose billetted total amount in scriptural currency is the greatest for performing the reimbursement.

10. The architecture according to claim 8, wherein the algorithm is configured to select as a priority the electronic money institution platforms whose associated electronic money institutions are established in the same country as the first user requesting the reimbursement.
